(19) United States
(12) Patent Application Publication
(10) Pub. No.: US 2004/0245172 A1
(43) Pub. Date: Dec. 9, 2004

(54) Filtration membrane

(76) Inventor: Rebecca Petersen, Fulda (DE)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/490,564

(22) PCT Filed: Sep. 4, 2002
(86) PCT No.: PCT/EP02/09904

(30) Foreign Application Priority Data
Sep. 18, 2001 (DE) 101 45 968.8

(51) Int. Cl. B01D 71/00

(52) U.S. Cl. 210/510.1; 210/500.21

(57) ABSTRACT

This invention relates to porous formed bodies, especially membranes, with a novel porous structure on the basis of thermoplastic polymers, and to a method for producing such formed bodies and especially membranes. Membranes of this type can be used as filtration membranes.

This invention relates to porous formed bodies, and in particular to membranes, with a novel porous structure based on thermoplastic polymers, and to a method for producing such formed bodies and especially membranes. Membranes of that type can be used as filtration membranes.

Porous formed bodies have been described in prior art, in particular those in the form of membranes for filtering fluids in the micro- and macro-filtration range, for instance for prefiltering and final filtration of liquid substances in industrial, laboratory and environmental-protection applications. WO 99/38604, for example, describes porous foamed membranes produced from thermoplastic polymers and exhibiting a high level of open cells of at least 80% and a void volume of at least 75%. Although those membranes already offer good filtration properties, certain applicational requirements call for improved parameters such as selectivity and membrane flow characteristics.

It is therefore the objective of this invention to provide a novel type of porous formed bodies, and especially filtration membranes, that permit both a very high flow rate and a high degree of selectivity.

This objective is achieved with the embodiments characterized in the claims. In particular, a porous formed body is provided that is based on at least one thermoplastic polymer characterized by a porous primary structure comprising at least partially open pores or cells, and a porous secondary structure having pores in the pore walls. The structure constituting the porous formed body may be in the form especially of a foam structure. The foam structure that constitutes the formed body according to the invention has preferably a porous primary structure with an open cell structure of ≧75% and a void volume of ≧85%, preferably ≧95%. The formed body according to the invention may especially be in the form of a membrane for the filtering of fluids in the micro- and macro-filtration range, for instance for the prefiltering and final filtration liquid substances in industrial, laboratory and environmental-protection applications.

Another object of this invention is a membrane having a foam structure based on at least one thermoplastic polymer, said foam structure comprising pores as the porous primary structure exhibiting an open cell structure of ≧75% and pores in the pore walls as a porous secondary structure, with a void volume of ≧85%, preferably ≧95%. The pores constituting the porous primary structure are spherical or polyhedral in shape and are adjacent to one another via a pore wall whose thickness is preferably in the range of about 10⁻⁷ m. The pore size is generally selectable as a function of the manufacturing conditions as will be explained below. The pores are preferably of a uniform pore size in the range of from 1 μm to 200 μm and more preferably from 30 μm to 200 μm. Depending on the pore size, the foam structure usually exhibits a pore density (cell density) of about 10⁶ pores/cm³ for pore sizes of about 200 μm and about 10¹³ pores/cm³ for pore sizes of about 1 μm. The standard deviation of the average pore diameter of the open pores in the porous primary structure is preferably <20%.

The pore walls of the pores are not impermeable but instead exhibit a pore-forming perforation, referred to as the “porous secondary structure”. These pores or net-like perforations or meshed openings have a pore diameter of ≦10 μm, preferably 0.1 μm to 10 μm.

The thermoplastic polymers that can be employed for the purpose of this invention preferably include amorphous and/or semi-crystalline thermoplastic polymers selected from among such polyolefins as polypropylene, polyesters, polyamides, polysulfones, polyethersulfones, polystyrene, cellulose derivatives, or their substitution products and mixtures thereof, to provide the structure of the present invention, comprising pores as the porous primary structure and pores in the pore walls as the porous secondary structure.

The membranes according to the invention may be unreinforced or reinforced on one or both sides. In particular, as an example, the reinforcing material may support on one or both sides a membrane of the invention or reinforce a membrane according to the invention on one or both sides. Suitable reinforcement materials include foils, tissue, woven or nonwoven fabrics from metallic or polymeric materials. Preferred are materials composed of polymer fibers whose polymer is of the same group of polymers as the polymer or polymer mixture constituting the foam structure of the membrane of the invention. In a preferred embodiment of this invention, the polymer fibers consist of a first high-melting and extra-hard core polymer whose surface is completely or partly covered by a second polymer. Membranes thus configured are particularly deformation-resistant. The second polymer has a lower melting point than the first core polymer and is chemically resistant. It is preferably of the same polymer group as the polymer or the polymer mixture constituting the foam structure of the membrane per this invention.

The figures show the following:

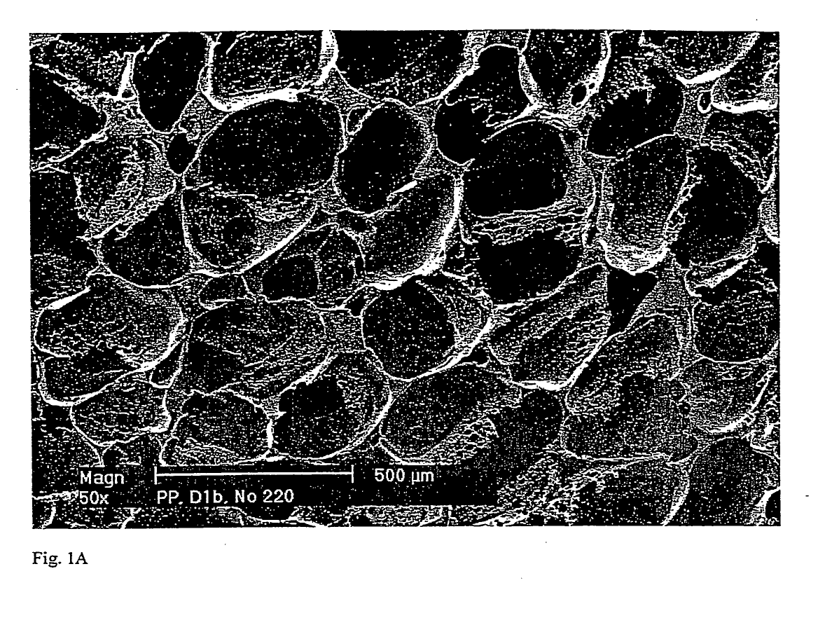

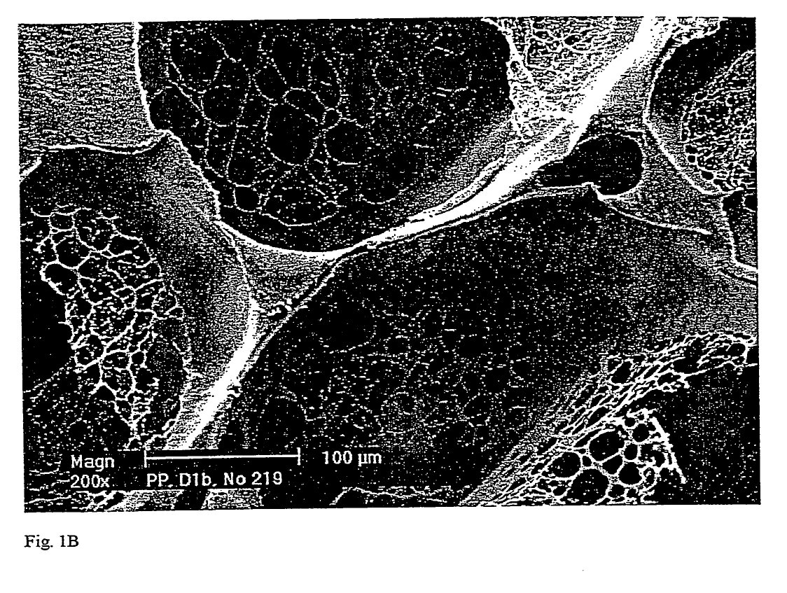

FIGS. 1A and 1B are scanning electron micrographs, with a 60× (A) and, respectively, 200× (B) magnification, through the cross section of a filtration membrane consisting of polypropylene foam and produced according to Example #1. The samples are obtained via a brittle break in liquid nitrogen. (A) clearly shows the porous primary structure with a uniform pore size of 100 to 200 μm and a pore density of about 10⁶ pores/cm³. (B) shows the porous secondary structure derived from the perforation of the cell walls. The pore diameter is on the order of about 10 μm.

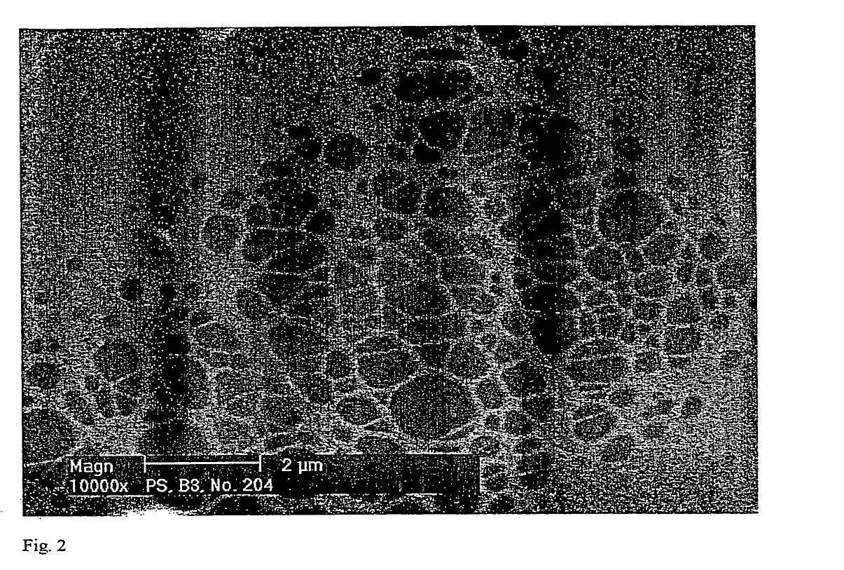

FIG. 2 is a scanning electron micrograph, with a 10,000× magnification, of a perforated pore wall, with the mesh openings (“pore diameters”) in this sample being on the order of ≦1 μm.

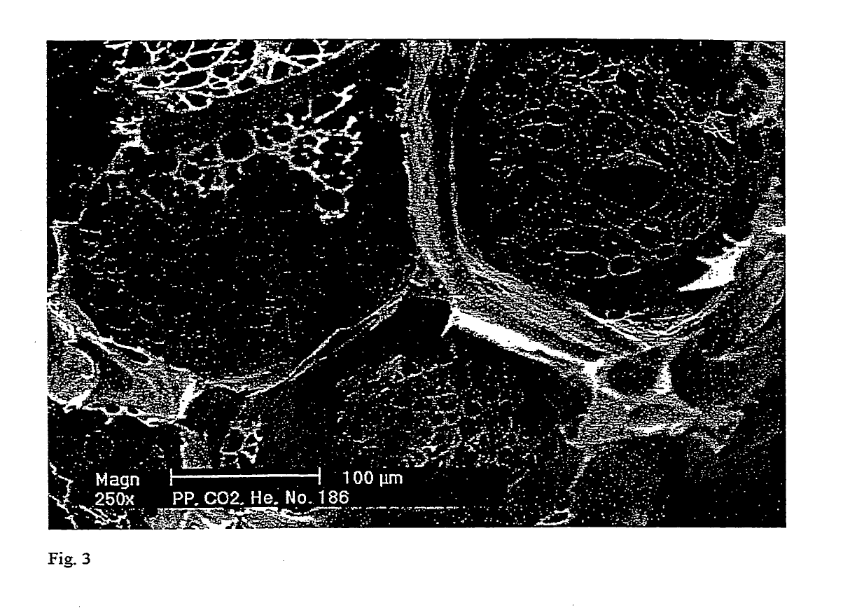

FIG. 3 is a scanning electron micrograph of a foam structure of the invention according to Example #2.

When used as a filtration membrane, the foamed structure according to the invention in which the pore walls of a relatively coarse-pored matrix exhibit a large number of net-like perforations or mesh openings with smaller diameters than the diameters of the pores of the coarsely porous matrix, and thus a sort of “dual structure”, surprisingly provides a very high flow rate with a simultaneously high degree of selectivity. In contrast to prior-art membranes having a symmetric or asymmetric sponge or finger structure, this novel foam structure of the membrane according to the invention features filtering surfaces in what resembles a series connection spaced one foam-pore size apart. The effective membrane thickness and corresponding resistance is thus kept small, in contrast to that of conventional three-dimensional sponge structures.

The void volume in % is calculated using the formula (1 raw density/polymer density×100. The raw density is defined as the foam bulk per volume unit and is determined by weighing the bulk and calculating the volume based on the linear dimension of a suitable sample body.

The open-cell or open-pore structure, i.e. the proportion of open pores in %, is measured using an air comparison pyknometer. That method, comparing a geometric volume of a sample body with a reference volume under identical pressure conditions, allows the determination of the air displacement by the foam material, i.e. the volume that corresponds to the closed pores including the bulk of the foam. The error introduced by cut surface pores is corrected by measuring sample bodies with varying surface/volume ratios. The open-cell structure is determined by extrapolating the measured open-cell structure to a surface/volume ratio of zero.

The pore size distribution is determined based on the slope of air flow curves as a function of pressure on the wetted membrane whose pores are filled with commercially available pore fillers typically used for that purpose. The air flow is measured with the aid of a Coulter porosimeter.

Another object of this invention is a method for producing the above-defined inventive formed bodies, especially membranes, whereby a pore- or cell-forming material containing a gas or a gas mixture is added in an extrusion device to a polymer melt consisting of at least one amorphous and/or semicrystalline polymer, the mixture of polymer melt and pore-forming agent is processed in a mixing station or mixing means into a single-phase or homogeneous melt and the pore-forming agent, after being channeled through a forming die, causes the single-phase melt to foam up as a result of the ensuing pressure drop while retaining the foam structure of the invention, said pore-forming agent being added in such amounts that the total concentration of the gas or gas mixture dissolved in the single-phase melt is >4% by weight as related to the polymer used and the processing temperature of the unary melt is lower than the processing temperature of the polymer melt. In a preferred embodiment of the inventive method the gas or gas mixture contains CO₂ and/or He. The processing temperature of the single-phase melt is preferably between 20-100° C. below the processing temperature of the polymer melt. In this context, the term “processing temperature” refers to the pure-polymer processing temperature recommended by the manufacturer concerned, i.e. without the pore-forming agent, for smooth extruder operation.

The general procedural steps for producing the inventive formed bodies or membranes and the extruder employed are described in WO 99/38604. In particular, a polymer melt consisting of at least one amorphous or semicrystalline polymer is passed under pressure (60 to 100 bar) through the single- or dual-screw extruder of an extrusion device. In the second of the three extruder sections the pore-forming agent is added. The latter may be for instance a gas or a gas mixture consisting of carbon dioxide, nitrogen, helium or some other inert gas. In the process, more pore-forming agent is injected into the polymer melt than would be able under the temperature or pressure conditions prevailing in the polymer melt to dissolve thermodynamically, i.e. that there is surplus gas or gas mixture. Downstream from the extrusion cylinder a cooling extension may optionally be used to intensify the mixing effect of the extruder. The polymer/gas mixture is subsequently fed, by means of a gear pump, into an additional mixing stage such as a static mixer and heat exchanger. That additional mixing stage terminates at its exit in a second gear pump, making it possible to build up in the additional mixing stage a pressure level that is independent from the extruder pressure. The pressure pattern in the mixing stage depends on the equipment parameters (diameter of the individual heat exchanger tubes, length etc.) and on the throughput rate and viscosity of the melt. That permits setting the input pressure at ≧400 bar and the output pressure at ≧300 bar, and (ii) the melt can be cooled for instance by ΔT=50° C. and preferably ΔT=100° C., taking advantage of the softening effect of the melt. Both actions bring about augmented gas solubility, causing the surplus gas content to dissolve. The second gear pump then feeds the homogeneous polymer/gas solution or single-phase melt into the extruder die whose profile determines its shape. As the polymer exits the die, the polymer foams up into the foam structure according to this invention. The pore size and pore density are determined by the concentration of the homogeneously dissolved gas.

The following examples will explain this invention in more detail.

### EXAMPLE #1

The extrusion devices correspond to those described in WO 99/38604. Granulated polypropylene (PPC 3660 by Fina) is extruded, at a throughput rate of 6 kg/h, through an extruder that is heated to 180° C. By way of a metering device, CO₂ gas, at 4.1% by weight relative to the polymer used, is injected at a pressure of 170 bar. The gear pump feeds the polymer/gas mixture into the mixing station. There, a pressure can be selected that is independent of the pressure in the extruder. The pressure in the gear pumps is set at a level that, given a melting temperature of about 175° C., the resulting output pressure is about 150 bar. The dwell time in the mixing station is about 15 to 20 minutes. The pressure downstream from the second gear pump is about 155 bar.

Using 4.1 weight-% of CO₂ and a melt-temperature of 175° C. produces the foam structure illustrated in FIGS. 1A and 1B. The pore size in the foam is about 150 μm, the pore density is 1×10⁶ pores/cm³ and the void volume is >95%. There is a strongly accentuated porous secondary structure, resulting in a very high porosity level.

### EXAMPLE #2

The procedure is the same as in Example #1 except that the gas is a mixture of 5% CO₂ and 0.65% helium. With a melt temperature of 175° C., the resulting foam structure is as shown in FIG. 3. The pore size in the foam is about 150 μm, the pore density is 1×10^{6 pores/cm}³ and the air-space volume is >95%. There is a strongly accentuated porous secondary structure, resulting in a very high porosity level.

1. A porous formed body based on at least one thermoplastic polymer, characterized by a structure comprising pores as a porous primary structure and pores in the pore walls as a porous secondary structure.

2. The formed body according to claim 1, wherein said structure is a foam structure.

3. The formed body according to claim 2, wherein the foam structure has pores as a porous primary structure with an open-cell structure of ≧75% and void volume of ≧85%.

4. The formed body according to claim 1, having the form of a membrane.

5. A membrane having a foam structure on the basis of at least one thermoplastic polymer, said foam structure comprising pores as a porous primary structure with an open-cell structure of ≧75% and pores in the pore walls as a porous secondary structure, as well as a void volume of ≧85%.

6. The membrane according to claim 5, wherein the pore diameter in the porous primary structure is in the range of from 30 μm to 200 μm.

7. The membrane according to claim 5, wherein the standard deviation of the average pore diameter in the porous primary structure is <20%.

8. The membrane according to claim 5, wherein the pore diameter of the porous secondary structure is ≦10 μm.

9. The membrane according to claim 5, wherein the thermoplastic polymer is selected from among polyolefins, polyesters, polyamides, polysulfones, polyethersulfones, polystyrene, cellulose derivatives, their substitute products and mixtures thereof.

10. The membrane according to claim 5, wherein said membrane is reinforced on one or both sides thereof.

11. A method for producing a porous formed body, in particular a membrane, as described in one of the preceding claims, wherein a pore-forming agent containing a gas or gas mixture is added in an extrusion device to a polymer melt consisting of at least one amorphous and/or semicrystalline polymer, the mixture of polymer melt and pore-forming agent being processed in a mixing station into a single-phase melt and, after passing through a forming die, the pore-forming agent causing the single-phase melt to foam up as a result of the associated pressure drop while retaining its foam structure, the pore-forming agent being added in such amounts that the total concentration of the gas or gas mixture dissolved in the single-phase melt is >4% by weight, and the processing temperature of the single-phase melt is lower than the processing temperature of the polymer melt.

12. The method according to claim 11, wherein the gas or gas mixture contains CO₂ and/or He.

13. The method according to claim 11, wherein the processing temperature of the single-phase melt is 20-100° C. lower than the processing temperature of the polymer melt.

14. The formed body according to claim 2, having the form of a membrane.

15. The formed body according to claim 3, having the form of a membrane.

16. The membrane according to claim 6, wherein the standard deviation of the average pore diameter in the porous primary structure is <20%.

17. The membrane according to claim 6, wherein the pore diameter of the porous secondary structure is ≦10 μm.

18. The membrane according to claim 7, wherein the pore diameter of the porous secondary structure is ≦10 μm.

19. The membrane according to claim 16, wherein:
the pore diameter of the porous secondary structure is ≦10 μm;
the thermoplastic polymer is selected from among polyolefins, polyesters, polyamides, polysulfones, polyethersulfones, polystyrene, cellulose derivatives, their substitute products and mixtures thereof;
said membrane is reinforced on one or both sides thereof.

20. The method according to claim 12, wherein the processing temperature of the single-phase melt is 20-100° C. lower than the processing temperature of the polymer melt.
